(19) United States
(12) Patent Application Publication
(10) Pub. No.: US 2010/0201243 A1
(43) Pub. Date: Aug. 12, 2010

(54) HIGH-PRESSURE DISCHARGE LAMP

(75) Inventor: Paul Braun, Meitingen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/602,498

(22) PCT Filed: May 28, 2008
(86) PCT No.: PCT/EP2008/056522

§ 371 Date: Dec. 1, 2009

(30) Foreign Application Priority Data
Jun. 1, 2007 (DE) 20 2007 007 774.2

(51) Int. Cl. H01J 61/36; H01J 61/02

(52) U.S. Cl. 313/113; 313/623

(57) ABSTRACT

A high-pressure discharge lamp is provided. The high-pressure discharge lamp may include a ceramic discharge vessel, electrodes respectively being guided out of the discharge vessel by means of a leadthrough system via capillaries, wherein at least one leadthrough system is at least of tripartite form, including a first leadthrough part that is at the front with reference to the discharge, is corrosion resistant and is held entirely in the capillary, and a second, middle leadthrough part that is not corrosion resistant and is likewise held entirely in the capillary, there being adjacent thereto a third, rear, corrosion resistant leadthrough part, a soldering glass covering a segment of the first leadthrough part up to a segment of the third leadthrough part such that the soldering glass entirely covers the second, middle leadthrough part, the middle leadthrough part being sunk in the capillary to a depth of at least 0.1 mm.

### TECHNICAL FIELD

The invention is based on a high-pressure discharge lamp in accordance with the preamble of claim 1.

### PRIOR ART

DE 2020060161890 discloses a high-pressure discharge lamp, in the case of which a ceramic discharge vessel is operated directly in air, or is accommodated in an outer envelope that is not sealed in a gastight fashion.

### DESCRIPTION OF THE INVENTION

The object of the present invention is to operate a high-pressure discharge lamp with ceramic discharge vessel in air, in particular in an open fashion or in an outer envelope that is not sealed in a gastight fashion, and to improve the service life in so doing.

This object is achieved by characterizing features of claim 1.

Particularly advantageous refinements are to be found in the dependent claims.

The invention particularly enables the operation of ceramic burners of high-pressure discharge lamps in air-filled outer bulbs or another outer envelope such as a reflector, that need not be sealed in a gastight fashion.

The electrode system of the discharge vessel is assembled from an electrode, mostly being from tungsten, and a leadthrough composed of three parts, specifically from a molybdenum pin with winding and recessed niobium pin, as well as a corrosion resistant end part, specifically of a molybdenum pin with winding.

This tripartite leadthrough is used for the purpose of operating a ceramic discharge vessel particularly reliably in air. The niobium pin must be protected against corrosion in air. It is therefore recessed in the capillary in order to lengthen the sealing section. Specifically, it has emerged that the customary soldering glass is so porous and blistered that in the course of operation air diffuses as far as the niobium pin when the sealing section is selected to be too short.

The soldering glass used to seal the burner serves in this case simultaneously to protect the non-corrosion resistant middle part of the leadthrough, such as a niobium pin or similar material as set forth in EP 587238. It is not sufficient in this case for the soldering glass to sheath this pin entirely, rather it also needs to have a sufficient sealing section up to the outer edge in order to ensure a comparable service life.

A further feature for ensuring a long service life is that the corrosion resistant end part must not be a molybdenum pin, since the latter cannot decrease stresses adequately and therefore cracks can occur in the soldering glass and limit the service life. Instead of this, it is required likewise to make use of a winding with core pin as end part. The dimensions thereof can preferably be designed in a fashion similar to the winding on the front side. This end part or the core pin thereof can then serve to make contact between the burner and the supply leads or the lamp frame outside the discharge vessel. However, it is also possible to insert a connecting part therebetween.

In detail, the present invention relates to a high-pressure discharge lamp with a ceramic discharge vessel, electrodes respectively being guided out of the discharge vessel by means of a leadthrough system via capillaries. In this case, the leadthrough system is at least tripartite, including a front leadthrough part that is corrosion resistant and is held entirely in the capillary, and a middle leadthrough part that is not corrosion resistant and is likewise held entirely in the capillary, there being adjacent thereto a rear, corrosion resistant end part that includes a core pin and winding pushed thereon, a soldering glass covering some of the third leadthrough part up to the corrosion resistant end part, and in this case the middle leadthrough part being completely covered, the middle leadthrough part being recessed in the capillary to a depth of at least 0.1 mm.

The front leadthrough part preferably has at least one section that faces the middle leadthrough part and includes a molybdenum core pin and a winding made from molybdenum pushed thereon, since the tightness with respect to the discharge volume is best ensured thereby.

The rear leadthrough part preferably has at least one section that faces the middle leadthrough part and includes a molybdenum core pin and a winding made from molybdenum pushed thereon.

In particular, the discharge vessel is accommodated in an outer envelope. The outer envelope is preferably an outer bulb or a reflector part.

The middle leadthrough part is preferably fabricated from niobium. It serves chiefly to relieve axial and/or radial forces in the sealing region, and preferably has a length of from 0.5 to 3 mm. The gap width should be in the region of the middle leadthrough part at approximately 25 to 45 μm.

The front leadthrough part is preferably fabricated entirely from molybdenum. By way of example, this can be in the form of a continuous system of core pin and winding, or of a molybdenum pin attached thereto at the front. The gap width should be sufficiently large in the case of the winding, typically 40 to 80 μm.

The ceramic discharge vessel is preferably made from Al₂O₃, for example PCA, or else sapphire, or else AlN. It is sealed at one or two ends.

Use may be made as soldering glass of conventional soldering glasses such as, for example, a mixture of Al₂O₃, SiO₂, and Dy₂O₃, see, for example, EP-A 587 238 for a more detailed explanation.

The electrode system can be fixed in a way known per se, and is significant for the invention only to the extent that it should save as much space as possible. It is preferred in this case to provide a solution by pinching or scraping, butt stop welding as well as a wire welded transversely to the leadthrough etc. are also possible in principle.

The novel sealing principle can be used at wattages from 10 W to 400 W because a niobium wire is indispensible for the voltage budget in the capillaries of ceramic discharge vessels starting from an inside diameter of at least 0.3 mm for the capillary. However, the niobium must be adequately protected against air. In order to adequately ensure the seal against air, it is important for the weld point to the third part of the leadthrough to be recessed in the capillary to a depth of at least 0.1 mm. A depth of 0.3 to 2 mm is preferred for the end point of the niobium pin.

### BRIEF DESCRIPTION OF THE DRAWINGS

The aim below is to explain the invention in more detail with the aid of exemplary embodiments. In the drawings,

FIG. 1 shows a ceramic discharge vessel that is sealed at two ends;

FIG. 2 shows a detail of the leadthrough region at the end of the ceramic discharge vessel;

FIG. 3 shows a ceramic discharge vessel that is sealed at one end;

FIG. 4 shows a ceramic discharge vessel that is sealed at one end;

FIG. 5 shows a lamp with outer bulb; and

FIG. 6 shows a further exemplary embodiment of a leadthrough in the end region of the ceramic discharge vessel.

### PREFERRED EMBODIMENT OF THE INVENTION

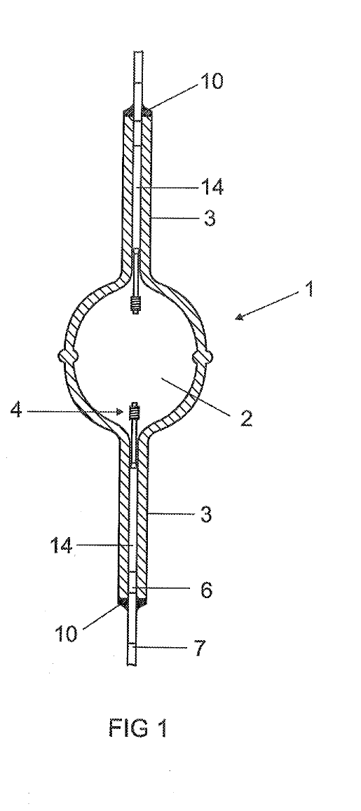

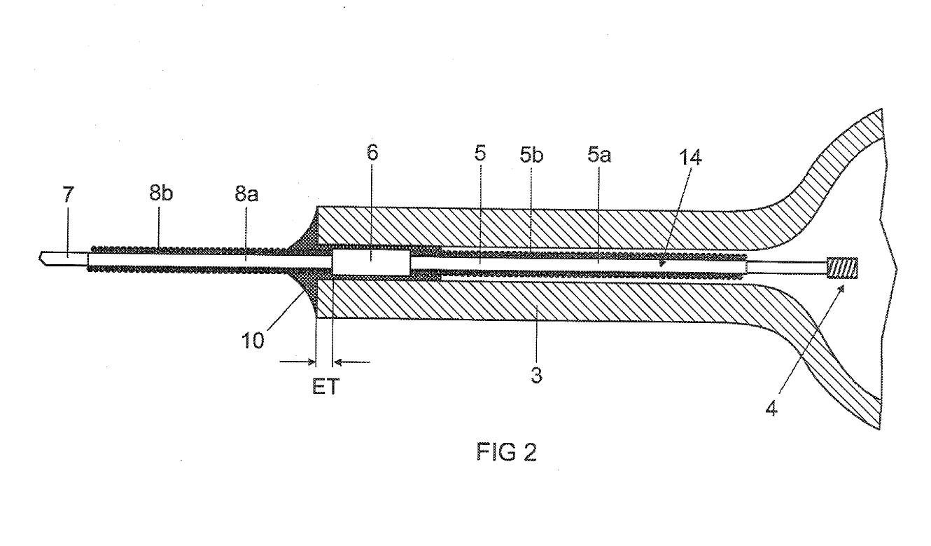

FIG. 1 is a schematic of a discharge vessel 1 for 70 W that is produced from Al₂O₃ and can be operated directly in air. The base required therefor is not illustrated. It has a bellied or else cylindrical discharge volume 2 and two elongated ends that are designed as capillary 3. An electrode system is respectively sealed in the capillary 3—see also FIG. 2. It consists of an electrode 4 made from tungsten, and of a leadthrough 14 as well as an outer supply lead 7.

FIG. 2 shows the design of the leadthrough 14, which is assembled here in tripartite fashion from a front leadthrough part 5, specifically a system composed of a molybdenum core pin 5a and winding 5b, a middle leadthrough part, here a short niobium pin 6, and a corrosion resistant end part 8, here a system composed of molybdenum core pin 8a and a molybdenum winding 8b. These three parts 5, 6, 8 are respectively interconnected, in particular butt-welded to one another, for example. The end part, at least in the vicinity of the soldering glass and, preferably, over a length of at least 50% of the molybdenum winding with the inclusion, in particular, of a region that is covered by the soldering glass so as to ensure an overlap, is advantageously coated with a thermally stable paste such that the molybdenum winding is additionally sealed with respect to air. Suitable as paste is a ceramic-metallic powder mixture, for example the Quarzcoat paste from Kager GmbH.

The niobium pin 6 is fitted such that it is entirely inserted into the capillary 3. In this case, it should preferably be seated in the capillary at a depth of at least 0.1 mm. A typical value of the insertion depth ET is 0.6 mm. The insertion depth need not be more than 2 mm. A typical outside diameter of the leadthrough part is 0.7 mm. The length of the niobium pin is typically 2 mm. The third part of the leadthrough, that is to say the end part 8, is a molybdenum core pin 8a with a typical diameter of 0.4 mm, to which a winding 8b made from molybdenum wire with a wire diameter of 0.14 mm is applied over the entire length of the core pin 8a. The core pin 8a is welded to the niobium pin 6.

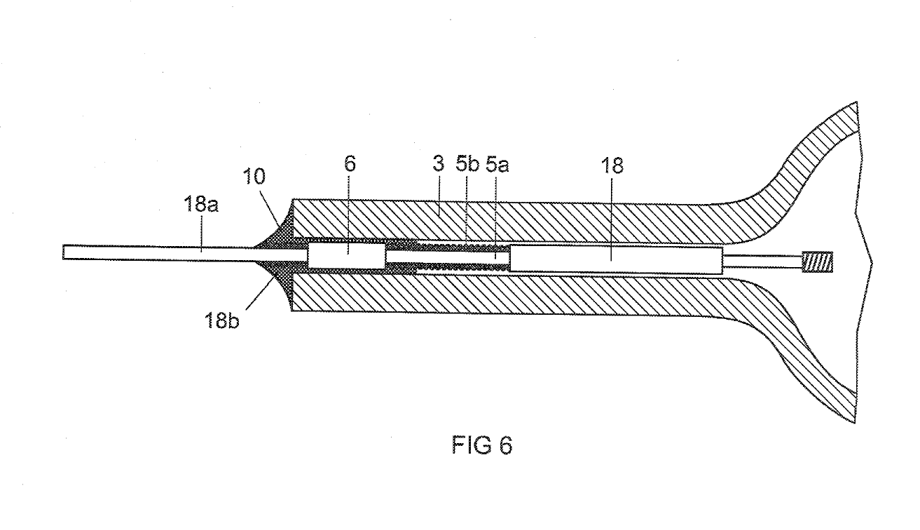

In another embodiment, see FIG. 6, the winding 18b of the third part of the leadthrough can also extend only over some of the core pin 18a of the third part of the leadthrough, in particular the winding 18b is only so long that, as illustrated, it is covered by the soldering glass.

So much soldering glass 10 is provided on the end of the capillary that some of the outer winding is covered, preferably at least 0.6 mm, with particular preference at least 1.5 mm, typically 2 to 3 mm. Furthermore, the niobium pin 6 is entirely sheathed by the soldering glass 10, and moreover the front winding 5b is covered by soldering glass 10 over a length that suffices for sealing against the aggressive fill in the discharge volume, at least over a segment of 0.6 mm, a value of approximately 1-2 mm being typical.

In detail, the front leadthrough part is approximately 9 mm long in the case of the 70 W lamp. The inside diameter of the capillary is 800 μm, the outside diameter of the first leadthrough part is 680 μm. It includes a molybdenum core pin of diameter 0.4 mm, and a molybdenum winding made from a wire of diameter 0.14 mm. Another system, possibly in multipartite fashion, can also be used as first leadthrough part, for example a molybdenum pin 18 as front part. All that is important here is to make use of a sufficiently long system composed of core pin and molybdenum winding in the sealing region near the niobium pin 6.

In the case of a 100 W lamp without additional coating, the service life is at least 7000 hours in air.

In the case that end pin and molybdenum winding 8a, 8b is replaced by a cermet pin, there is no need in principle for any additional coating.

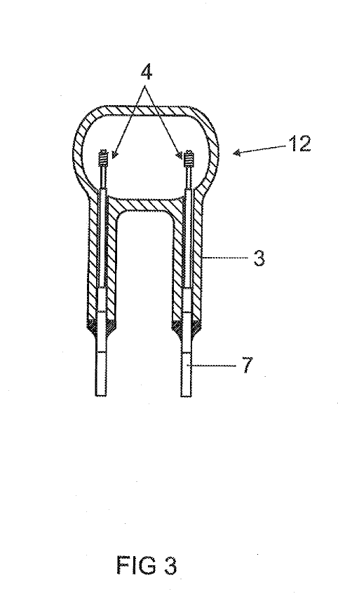

FIG. 3 shows a further exemplary embodiment of a ceramic discharge vessel 12 sealed at one end. Here, as well, use is made of a multipartite leadthrough 14, in a fashion similar to FIG. 2. The leadthroughs are arranged in two capillaries 3 that are guided out of one end of the discharge vessel in a fashion parallel to one another. They are assembled from three parts 5 and 6. The electrode system is completed by an electrode 4 and a supply lead 7.

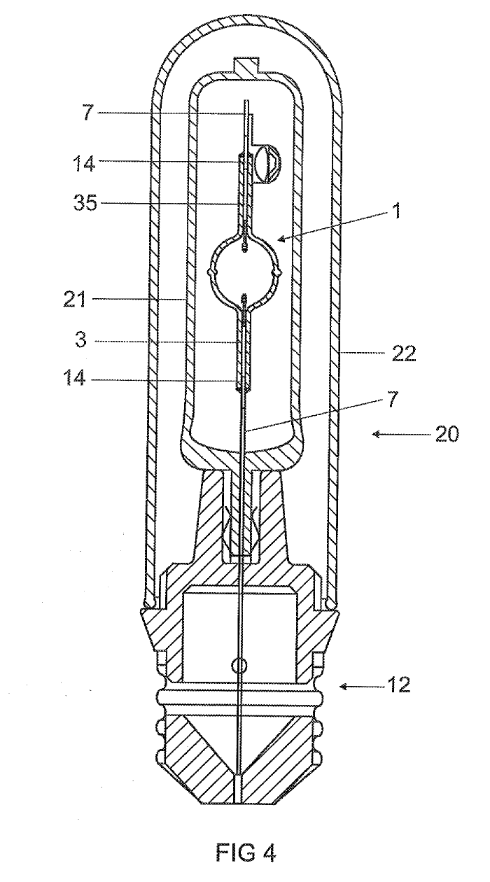

FIG. 4 shows a metal halide lamp 20 with envelope bulb 22 and screw base 12. Here, the discharge vessel 1 made from PCA is accommodated in an outer bulb 21. The outer bulb 21 is filled with air. The leadthrough 14 is similar to that in FIG. 2, but is illustrated here only schematically. Typical fills for such lamps are described in EP 587 238.

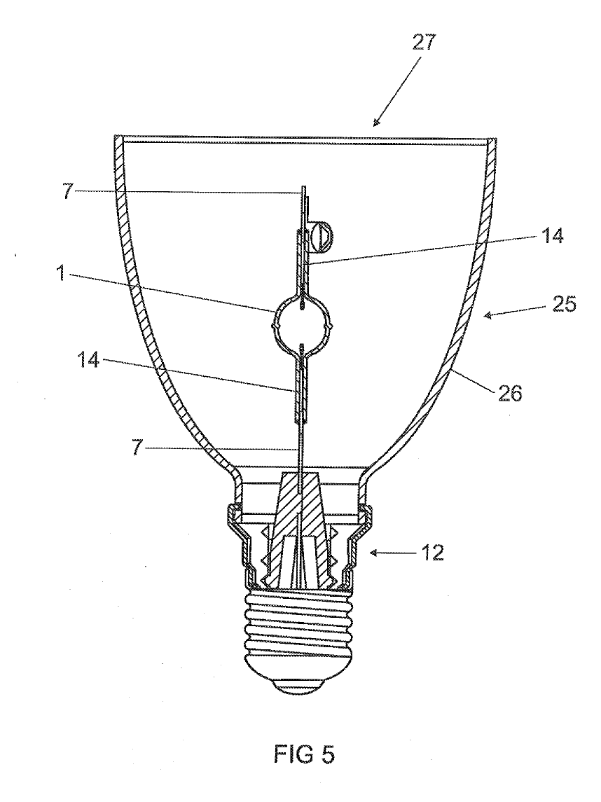

FIG. 5 shows a reflector lamp 25 with screw base 12. Here, the ceramic discharge vessel 1, which contains a metal halide fill and a leadthrough similar to that in FIG. 2, but illustrated here only schematically, is accommodated in a reflector 26 as envelope. The lamp is operated in air. The reflector therefore need not be sealed in a gastight fashion, that is to say it can dispense with a cover disk at the exit opening 27 of the reflector.

1. A high-pressure discharge lamp, comprising:
a ceramic discharge vessel,
electrodes respectively being guided out of the discharge vessel by means of a leadthrough system via capillaries,
wherein at least one leadthrough system is at least of tripartite form, comprising a first leadthrough part that is at the front with reference to the discharge, is corrosion resistant and is held entirely in the capillary, and a second, middle leadthrough part that is not corrosion resistant and is likewise held entirely in the capillary, there being adjacent thereto a third, rear, corrosion resistant leadthrough part, a soldering glass covering a segment of the first leadthrough part up to a segment of the third leadthrough part such that the soldering glass entirely covers the second, middle leadthrough part, the middle leadthrough part being sunk in the capillary to a depth of at least 0.1 mm.

2. The high-pressure discharge lamp as claimed in claim 1,
wherein the front leadthrough part comprises at least one section that faces the middle leadthrough part and comprises a molybdenum core pin and a winding made from molybdenum pushed thereon.

3. The high-pressure discharge lamp as claimed in claim 1,
wherein the rear leadthrough part comprises at least one section that faces the middle leadthrough part and comprises a molybdenum core pin and a winding made from molybdenum pushed thereon.

4. The high-pressure discharge lamp as claimed in claim 1,
wherein the discharge vessel is accommodated in an outer envelope.

5. The high-pressure discharge lamp as claimed in claim 1,
wherein the middle leadthrough part is fabricated from at least one of niobium and niobium-like material.

6. The high-pressure discharge lamp as claimed in claim 1,
wherein the rear leadthrough part is coated by a paste over some of its length.

7. The high-pressure discharge lamp as claimed in claim 1,
wherein the front leadthrough part is fabricated entirely from molybdenum.

8. The high-pressure discharge lamp as claimed in claim 4,
wherein the outer envelope is at least one of an outer bulb and a reflector part.

9. The high-pressure discharge lamp as claimed in claim 5,
wherein the middle leadthrough part has a length of from 0.5 to 3 mm.

10. The high-pressure discharge lamp as claimed in claim 6,
wherein the rear leadthrough part is coated by a paste over some of its length, also in a subregion that is covered by soldering glass.

11. A high-pressure discharge lamp with a ceramic discharge vessel, electrodes respectively being guided out of the discharge vessel by means of a leadthrough system via capillaries,
wherein at least one leadthrough system is at least of tripartite form, comprising a first leadthrough part that is at the front with reference to the discharge, is corrosion resistant and is held entirely in the capillary, and a second, middle leadthrough part that is not corrosion resistant and is likewise held entirely in the capillary, there being adjacent thereto a third, rear, corrosion resistant leadthrough part that comprises, a core pin and a winding pushed thereon, or comprises a cermet pin, a soldering glass covering a segment of the first leadthrough part up to a segment of the third leadthrough part such that the soldering glass entirely covers the second, middle leadthrough part, the middle leadthrough part being sunk in the capillary to a depth of at least 0.1 mm.

12. The high-pressure discharge lamp as claimed in claim 11,
wherein the front leadthrough part comprises at least one section that faces the middle leadthrough part and comprises a molybdenum core pin and a winding made from molybdenum pushed thereon.

13. The high-pressure discharge lamp as claimed in claim 11,
wherein the rear leadthrough part comprises at least one section that faces the middle leadthrough part and comprises a molybdenum core pin and a winding made from molybdenum pushed thereon.

14. The high-pressure discharge lamp as claimed in claim 11,
wherein the discharge vessel is accommodated in an outer envelope.

15. The high-pressure discharge lamp as claimed in claim 11,
wherein the middle leadthrough part is fabricated from at least one of niobium and niobium-like material.

16. The high-pressure discharge lamp as claimed in claim 11,
wherein the rear leadthrough part is coated by a paste over some of its length.

17. The high-pressure discharge lamp as claimed in claim 11,
wherein the front leadthrough part is fabricated entirely from molybdenum.

18. The high-pressure discharge lamp as claimed in claim 14,
wherein the outer envelope is at least one of an outer bulb and a reflector part.

19. The high-pressure discharge lamp as claimed in claim 15,
wherein the middle leadthrough part has a length of from 0.5 to 3 mm.

20. The high-pressure discharge lamp as claimed in claim 16,
wherein the rear leadthrough part is coated by a paste over some of its length, also in a subregion that is covered by soldering glass.
